(19) United States
(12) Patent Application Publication
(10) Pub. No.: US 2026/0356768 A1
(43) Pub. Date: Nov. 12, 2026

(54) METHODS OF SURFACE TREATING HONEYCOMB BODIES WITH INORGANIC DEPOSITS

(71) Applicant: CORNING INCORPORATED, CORNING, NY (US)

(72) Inventors: Pei Cong, Shanghai (CN); Cai Liu, Painted Post, NY (US); Huiqing Wu, Shanghai (CN)

(21) Appl. No.: 19/491,590

(22) PCT Filed: Jun. 30, 2023
(86) PCT No.: PCT/CN2023/104512

§ 371 Date: Dec. 9, 2025

(51) Int. Cl. C04B 38/00; C04B 41/45; C04B 41/84; C04B 41/85

(52) U.S. Cl. CPC C04B 38/0006; C04B 38/0096; C04B 41/4543; C04B 41/84; C04B 41/85

(57) ABSTRACT

Methods for treating a surface of a plugged honeycomb body having porous walls by atomizing an aqueous mixture, comprised of particles and a silane binder mixture comprised of a silane binder and water, to form an aerosol stream of aerosolized deposit precursors, and spray drying the aerosolized deposit precursors with a carrier gas to convey the aerosolized deposit precursors toward the plugged honeycomb body. Water is removed from the wetted particles and/or the particle-containing droplets. At least some of the aerosolized deposit precursors form agglomerates comprised of the particles and the silane binder. The aqueous mixture is advantageously essentially free of carboxylic acid. The aerosolized deposit precursors can be particles, wetted particles and/or particle-containing droplets.

### BACKGROUND

### Field

The present specification relates to methods of making porous bodies, such as porous ceramic honeycomb bodies, which comprise inorganic deposits, the deposits comprised of an inorganic filtration material.

### Technical Background

Wall-flow filters are employed to remove particulates from fluid exhaust streams, such as from combustion engine exhaust. Examples include diesel particulate filters used to remove particulates from diesel engine exhaust gases and gasoline particulate filters (GPF) used to remove particulates from gasoline engine exhaust gases. Exhaust gas to be filtered enters inlet cells and passes through the cell walls to exit the filter via outlet channels, with the particulates being trapped on or within the inlet cell walls as the gas traverses and then exits the filter.

There is a need to provide improved processes for applying inorganic deposits to honeycomb filter bodies, such as by using aqueous processes.

### SUMMARY

Aspects of this disclosure pertain to porous bodies and methods for their manufacture and use.

In one or more aspects, a method is disclosed herein for treating a surface of a plugged honeycomb body comprising porous walls, the method comprising generating an aerosol stream comprised of particles, wetted particles and/or particles-containing droplets (“aerosolized deposit precursors”) by atomizing an aqueous mixture comprised of particles, a silane binder, and water, wherein the aqueous mixture is essentially free of carboxylic acid, and conveying the aerosol stream toward the plugged honeycomb body with a carrier gas, wherein, during the conveying, water is removed from the wetted particles and/or particulate-containing droplets and causes at least some of the aerosolized deposit precursors to form agglomerates comprised of the particles and the silane binder, and wherein the agglomerates are deposited on or in the porous walls as the carrier gas passes through the porous walls.

In one or more other aspects, a method is disclosed herein for treating a surface of a plugged honeycomb body comprising porous walls, the method comprising: atomizing an aqueous mixture, comprised of particles and a silane binder mixture comprised of a silane binder and water, to form an aerosol stream of aerosolized deposit precursors, and spray drying the aerosolized deposit precursors with a carrier gas to convey the aerosolized deposit precursors toward the plugged honeycomb body, wherein water is removed from the wetted particles and/or the particle-containing droplets, wherein at least some of the aerosolized deposit precursors form agglomerates comprised of the particles and the silane binder, and wherein the aqueous mixture is essentially free of carboxylic acid. The aerosolized deposit precursors may be comprised of the particles, wetted particles and/or particle-containing droplets.

The following aspects and embodiments correspond to the aspects disclosed hereinabove.

The agglomerates are preferably formed before reaching the plugged honeycomb body.

The agglomerates may be lodged on, or in, or both on and in, the porous walls as the carrier gas passes through the porous walls. For example, the agglomerates are deposited and retained on, or in, or both on and in, the porous walls. The agglomerates can thus be deposited and retained on, or in, or both on and in, the porous walls

At least some of the agglomerates may aggregate into clusters during the spray drying.

At least some of the agglomerates may aggregate into clusters upon reaching the plugged honeycomb body.

Preferably, water is removed from the agglomerates by evaporation.

Preferably, substantially all of the water is removed from the agglomerates before reaching the plugged honeycomb body.

In embodiments, substantially all of the water is removed from the agglomerates after reaching the plugged honeycomb body.

The method may further comprise curing the agglomerates. In an aspect, the curing comprises heating the agglomerates. In an aspect, the curing comprises heating the plugged honeycomb body. In an aspect, the curing comprises exposing the plugged honeycomb body to a heating environment; in some embodiments, the heating environment comprises forced heated gas flow; in some embodiments, the heating environment comprises microwave radiation; in some embodiments, the heating environment comprises heating the plugged honeycomb body in an oven; in some embodiments, the heating environment does not exceed 130 °C.

In an aspect, the curing causes agglomerates to bind to the porous walls of the plugged honeycomb body and/or to each other.

In an aspect, substantially all of the water is removed from the agglomerates as a result of the curing.

In an aspect, the atomizing comprises forcing the aqueous mixture through a nozzle. In embodiments, the aqueous mixture is forced through the nozzle with a pressurized gas. In embodiments, the aqueous mixture is forced through the nozzle with compressed nitrogen or compressed air.

In an aspect, the aqueous mixture is free of siloxane. In embodiments, the aqueous mixture is free of alkoxysiloxane. In embodiments, the aqueous mixture is alkali-free; in embodiments, the aqueous mixture is sodium-free; in embodiments, the aqueous mixture is free of sodium silicate.

In an aspect, the aqueous mixture is free of silicate. In embodiments, the aqueous mixture is free of siloxane and silicate.

In an aspect, the aqueous mixture is a slurry or a suspension.

In an aspect, the aqueous mixture is free of acetic acid. In embodiments, the aqueous mixture is free of acetic acid and formic acid.

In an aspect, the silane binder comprises one or more functional organic groups. In embodiments, the silane binder comprises one or more functional organic groups, wherein the functional organic group is a glycidyl-group, an amine-group, a methacryl-group, a vinyl-group, or combinations thereof. In embodiments, the silane binder comprises a hydrolysis group, wherein the hydrolysis group is a methoxy-group, an ethoxy-group, or a combination thereof.

In an aspect, the silane binder comprises one or more silylalkoxy groups.

In an aspect, the silane binder mixture further comprises polyethylene glycol; in embodiments, the polyethylene glycol comprises a molar weight of 300 to 500; in embodiments, the polyethylene glycol comprises a molar weight of about 400.

In an aspect, the particles are comprised of an inorganic material; in embodiments, the particles are comprised of a refractory material; in embodiments, the particles are comprised of a metal oxide or a metal carbide; in embodiments, the particles are comprised of alumina, cordierite, silicon carbide, or combinations thereof.

In an aspect, the particles consist essentially of alumina, silicon carbide, or combinations thereof.

In an aspect, the particles consist essentially of alumina.

In an aspect, the particles are in an aqueous particle suspension prior to being mixed with the silane binder mixture.

In an aspect, the porous walls of the plugged honeycomb body are comprised of a metal oxide or a metal carbide.

In an aspect, the silane binder mixture is formed by mixing together the silane binder and polyethylene glycol in a waterless environment, then mixing together with water.

The method may further comprise mixing together the binder mixture and the inorganic particle suspension to form an aqueous particulate-binder suspension. In embodiments, the inorganic particle suspension comprises water and inorganic particles.

The method may further comprise milling the inorganic particles to a reduced size prior to mixing the inorganic particles with the binder mixture; in embodiments, the inorganic particles are milled such that a median particle size (d50) of the particles is less than 1.0 μm; in embodiments, the inorganic particles are milled such that a median particle size (d50) of the particles is less than 0.9 μm; in embodiments, the inorganic particles are milled such that a median particle size (d50) of the particles is less than 0.8 μm.

In an aspect, the aqueous mixture comprises 5 to 15 wt % inorganic particles, 2.0 to 5.0 wt % silane binder, and 0.5 to 2.0% polyethylene glycol.

In an aspect, the aqueous mixture comprises 7 to 13 wt % inorganic particles, 2.5 to 4.5 wt % silane binder, and 0.5 to 1.5% polyethylene glycol.

In an aspect, the aqueous mixture comprises 10 to 12 wt % inorganic particles, 3.0 to 4.0 wt % silane binder, and 0.7 to 1.2% polyethylene glycol. In embodiments, the inorganic particles are comprised of alumina, the silane binder is, and the polyethylene glycol has a molar weight of 400.

In an aspect, the atomizing comprises forcing the aqueous mixture through a nozzle; in embodiments, the aqueous mixture is forced through the nozzle with a pressurized gas; in embodiments, the aqueous mixture is forced through the nozzle with compressed nitrogen or compressed air.

In an aspect, the agglomerates produced by the above methods are essentially spherical in shape. In embodiments, the agglomerates form a deposit microstructure of packed spherical agglomerates.

Additional features and advantages will be set forth in the detailed description, which follows, and in part will be readily apparent to those skilled in the art from that description or recognized by practicing the embodiments described herein, comprising the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 shows an exemplary embodiment of a silane binder for the aqueous process disclosed herein.

FIG. 2 schematically depicts results of ICP analysis for the adhesion performance of the 6040 silane binder of FIG. 1 with alumina particles under various conditions.

FIG. 3 shows the hydrolysis and condensation structure of the silane binder Z-6040 of FIG. 1 including T0^{OH} uncondensed initial state, and corresponding T1, T2, T3 condensed states.

FIG. 4A is an SEM image of an aqueous-based sample made with a first batch without acetic acid.

FIG. 4B is an image of an aqueous-based sample made with a second batch with acetic acid.

FIG. 4C schematically depicts agglomerate size accumulative log normal distribution fitting results including D10, D50 and D90 of agglomerates of the first and second batches corresponding to FIGS. 4A and 4B.

FIG. 4D schematically depicts a histogram of agglomerate size distribution of the first and second batches corresponding to FIGS. 4A-4C.

FIG. 5 shows Table 4 with the statistical results of agglomerate size referring to log normal distribution for samples made with an ethanol-based process and alkoxysiloxane binder, an aqueous-based process and silane binder with acetic acid, and an aqueous-based process and silane binder without acetic acid.

FIG. 6 schematically depicts an apparatus for depositing inorganic material according to embodiments disclosed herein.

FIG. 7A schematically depicts results of a Thermogravimetric (TG) analysis performed on an aqueous solution containing the silane binder Dowsil Z-6040 and polyethylene glycol in a 20% aqueous solution, ratio of 6040/PEG400: 3.3/1.

FIG. 7B schematically depicts results of a Thermogravimetric (TG) analysis performed on an aqueous solution containing the silane binder Dowsil Z-6040 in a 20% aqueous solution.

FIG. 8A schematically shows post-cure filtration efficiency versus IST loading for samples from an ethanol process and the aqueous process disclosed herein.

FIG. 8B schematically shows post-cure filtration efficiency versus post-cure pressure drop for the samples of FIG. 8A from an ethanol process and the aqueous process disclosed herein.

FIG. 9 shows Table 2 which lists the aqueous process parameters and conditions that were used to make samples.

FIG. 10 graphically illustrates water resistance test results for aqueous-based samples (with and without acetic acid AC) and ethanol-based samples.

FIG. 11A1 is an SEM image of an aqueous-based sample showing agglomerates stacking distribution under a GPF wall.

FIG. 11A2 is an SEM image of an aqueous-based sample showing alumina agglomerates stacking to form a high FE inorganic layer portion.

FIG. 11A3 is an SEM image of an aqueous-based sample showing high resolution image of alumina agglomerate.

FIG. 11B1 is an SEM image of an ethanol-based sample showing agglomerates stacking distribution under a GPF wall.

FIG. 11B2 is an SEM image of an ethanol-based sample showing alumina agglomerates stacking to form high FE inorganic layer portion.

FIG. 11B3 is an SEM image of an ethanol-based sample showing high resolution image of alumina agglomerate.

### DETAILED DESCRIPTION

Reference will now be made in detail to embodiments of methods for forming honeycomb bodies comprising a porous honeycomb body comprising inorganic deposits (or “filtration deposits”) on, or in, or both on and in, the porous ceramic walls of the honeycomb body matrix, embodiments of which are illustrated in the accompanying drawings. Filtration deposits comprise material that was deposited into the honeycomb body, as well as compounds that may be formed, for example, by heating, from one or materials that were originally deposited. For example, a binder such as an alkali-free binder and an adhesion promoter may be transformed by heating into an organic component which is eventually burned off or volatilized, while an inorganic component (such as silica) remains contained within the honeycomb filter body. Whenever possible, the same reference numerals will be used throughout the drawings to refer to the same or like parts.

### DEFINITIONS

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”.

A “honeycomb body,” as referred to herein, comprises a ceramic honeycomb structure of a matrix of intersecting walls that form cells which define channels. The ceramic honeycomb structure can be formed, extruded, or molded from a plasticized ceramic or ceramic-forming batch mixture or paste. A honeycomb body may comprise an outer peripheral wall, or skin, which was either extruded along with the matrix of walls or applied after the extrusion of the matrix. For example, a honeycomb body can be a plugged ceramic honeycomb structure which forms a filter body comprised of cordierite or other suitable ceramic material. A plugged honeycomb body has one or more channels plugged at one, or both ends of the body.

As used herein, “green” or “green ceramic” are used interchangeably and refer to an unsintered or unfired material, unless otherwise specified.

### Methods

In aspects herein, an aqueous-based processes to generate a small amount of porous inorganic deposits or thin layers on or in walls of honeycomb filters are disclosed. The microstructure of the inorganic deposits or layers can be used to significantly improve the filtration efficiency of a honeycomb filter without incurring more than a minimal additional pressure drop penalty, which is especially important for utilization in treating vehicle exhaust emission. The inorganic deposits are preferably comprised of small inorganic agglomerates bounded together or to the honeycomb body by a silane binder. The stacked agglomerates can aggregate on the honeycomb body walls to form one or more thin porous structures. We have found that silane binder, in some embodiments with specific Si—O structure, can supply binding strength for aqueous based inorganic surface treatment, even for high temperature applications of the final honeycomb filter body. Flexibility of hydrolysis group and functional group in binder chemical structure can adjust reaction activity and enable a family of chemicals that can be applied in these processes.

In an aspect, the aqueous-based processes generally comprise four steps: 1) batching, with physical treatment of raw materials to prepare an aqueous-based suspension; 2) spray-drying the aqueous suspension to generate agglomerates aerosol, then agglomerates aerosol depositing onto a honeycomb body by drying gas flow; and 3) curing the honeycomb filter body surface treated with filtration deposits to strengthen the bonding between one or more inorganic structures or constituents. Silane coupling agents were shown to be able to function as an aqueous binder for the aqueous processes.

For example, in an embodiment, the wall surfaces of a plugged honeycomb filter body which were treated with deposits of inorganic particle agglomerates with an inorganic filtration material loading of 7.0 g/L (i.e. the inorganic deposited material measured in grams per overall volume of the honeycomb body) by an aqueous process disclosed herein resulted in increasing the filtration efficiency of a soot-free (clean) gasoline particulate filter by 20% as measured by a filtration efficiency test utilizing cigarette smoke.

In one or more aspects disclosed herein, and aqueous-based system, or aqueous-based method, can advantageously comprise a rather low temperature curing to form a durable or sturdy filtration material structure.

In one or more aspects, or one or more embodiments, disclosed herein, the process and/or system disclosed herein can provide the following advantages: significant cost advantages over an ethanol-based process, such as described in US-2021-0354071 A1 and WO22/006768, for example due to low cost of raw materials (for example the solvent may constitute >80 wt. % of the total materials associated with applying the filtration deposits), and no need for a specific pollution abandonment system, for example to handle ethanol; and aqueous-based system or method having fewer operation safety concerns and less complexity as compared to an ethanol-based process; plugged honeycomb filter bodies having a high clean filtration efficiency (for example above 92% spoke bench FE) and acceptable pressure drop penalty (for example less than 20% increase due to the filtration deposits) as compared to a bare gasoline particulate filter having the same plugged honeycomb filter body but without the surface treatment of filtration material deposits; a silane binder serving as a coupling agent can provide an effective binder for the inorganic filtration material (particles) such as an Dowsil Z-6040; and/or aqueous-based process or system which is compatible with precious metal such as for potential catalytic applications.

Unless otherwise noted herein, the plugged honeycomb filter bodies evaluated comprised a matrix of intersecting porous walls of average porosity 55% (as measured by mercury porosimetry) and 8 mil average wall thickness in a honeycomb structure with a cell density of 200 cells per square inch (CPSI). Filtration efficiency in the clean state was evaluated by cigarette smoke FE test which detects particle sizes of greater than 300 nanometers, at a testing flow velocity of 1.7 m/s. Known FE testing equipment and protocol were used.

Regarding character of the chemistry of organosilanes useful as a binder herein, we have found that the silane coupling agent can have a silylalkoxy on one end of the silane to react with surfaces that bear hydroxyl groups, and the functional group on the other end can serve other purposes, based on its application. Based on that, silanes disclosed herein can disperse in aqueous systems and should be able to serve as binder between metal oxide particles or agglomerates or structures such as walls.

In embodiments evaluated, we evaluated silane from the family of organosilanes, which we have found have the capability of acting as a durable binder for inorganic surface treatments generated by an aqueous process.

In embodiments evaluated, we tested a silane from the family of organosilanes, namely GPTMS, which we have found has the capability of acting as a durable binder for inorganic surface treatments generated by an aqueous process.

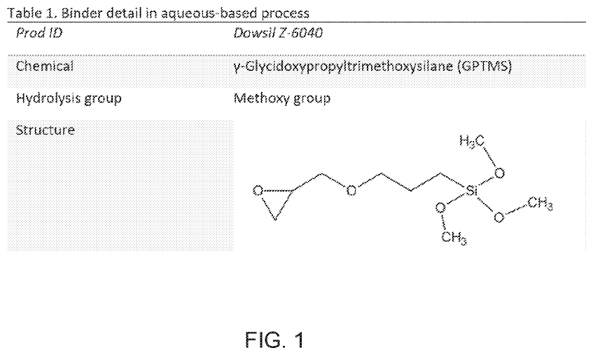

FIG. 1 shows Table 1 which lists GPTMS including its chemical structure.

We also evaluated the adhesion behavior between Z-6040 and alumina particles, and the adhesion impact on binding effectiveness.

In order to evaluate the adhesion behavior, we performed ICP analysis.

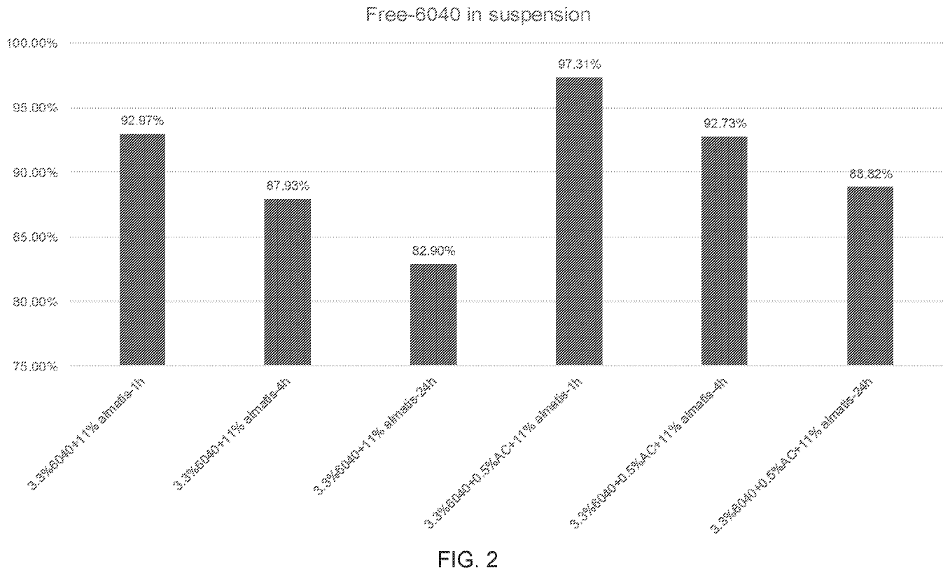

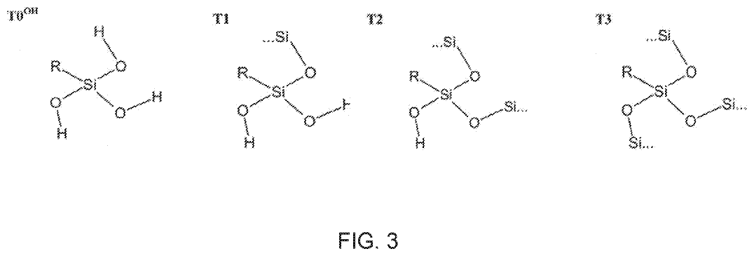

First, mixtures of Z-6040 with alumina particle in aqueous solution under different conditions were prepared, then the remaining Z-6040 in solution where solid particles (mainly alumina particle and substance(s) that adhere on alumina particle) were removed by centrifuge. The remaining concentration of Z-6040 is shown in FIG. 2, and as evident, when mixing time increases, for various mixing conditions, the remaining Z-6040 in residual solution decreases, which means Z-6040 was removed alongside with alumina particles during centrifuge. Also, different solution condition also affects adhesion behavior, as shown in FIG. 2, when acetic acid (sometimes referred to herein as “AC”) was added prior to Z-6040, ICP analysis reveals that more remaining Z-6040 in the residual solution, which tends to indicate that acetic acid prevents the adhesion behavior between Z-6040 and alumina particle, and follow-up IST reliability test backed up this hypothesis, when less Z-6040 adhere on alumina particle during batching process, IST strength decreases. Without being bound by any particular theory, and referring to previous research performed on Z-6040 (by François de Buyl and Axel Kretschmer), adhesion behavior appears to be dominated by the silylalkoxy groups of Z-6040, which can react with metal oxide surfaces bearing hydroxyl groups. The reaction between them is believed to be based on hydrolysis and condensation of silylalkoxy groups, where the structure of different states of those groups are shown in FIG. 3 which shows hypothetical hydrolysis and condensation structure of Z-6040: T0^{OH} uncondensed initial state, and corresponding T1, T2, T3 condensed states.

Accordingly this coupling mechanism appears to indicate that silanes that bear silylalkoxy groups may be used as an effective binder for the inorganic filtration deposit production disclosed herein, and the functional organic groups on the other extremities of that silane may be adapted or altered for particular applications; for example we tested glycidyl-groups of Z-6040, as well as other groups such as amine, methacryl-, vinyl-, etc. which can also be effective, wherein altering the functionality group can improve compatibility with a particular application scenario. Due to the nature of the molecules of organosilanes, reactive moieties that can act similarly as silylalkoxy groups of Z-6040, could also be utilized as an effective inorganic surface treatment binder, such as GPTES which comprises ethoxysilane instead of methoxysilane as in Z-6040.

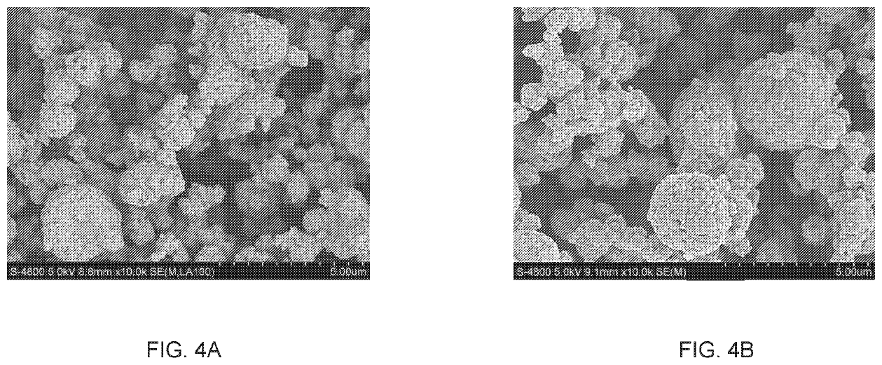

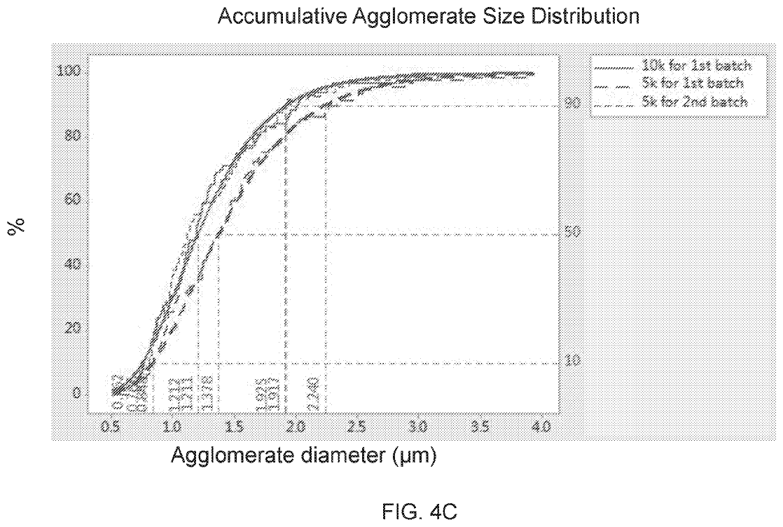

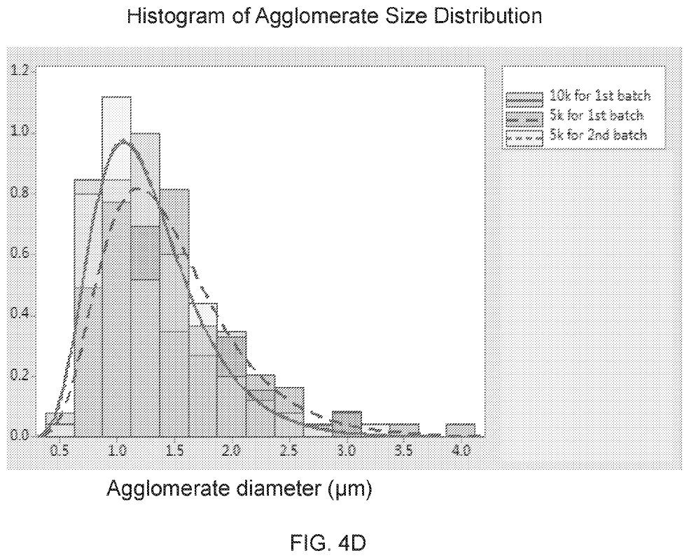

FIGS. 4A and 4B show SEM images of inorganic deposits formation comprising spherical “snowball”-shaped agglomerates comprised of alumina for two conditions: FIG. 4A is an image of an aqueous-based sample made with a first batch without acetic acid; FIG. 4B is an image of an aqueous-based sample made with a second batch similar to the first batch but with acetic acid.

FIG. 4C shows a histogram of accumulative distribution and its lognormal distribution fitting for two conditions based on SEM image analysis of the example of FIG. 4A 5A (first batch) and FIG. 4B (second batch).

FIG. 4D shows a histogram of agglomerate size distribution based on SEM image analysis of the examples of FIG. 4A (first batch) and FIG. 4B (second batch).

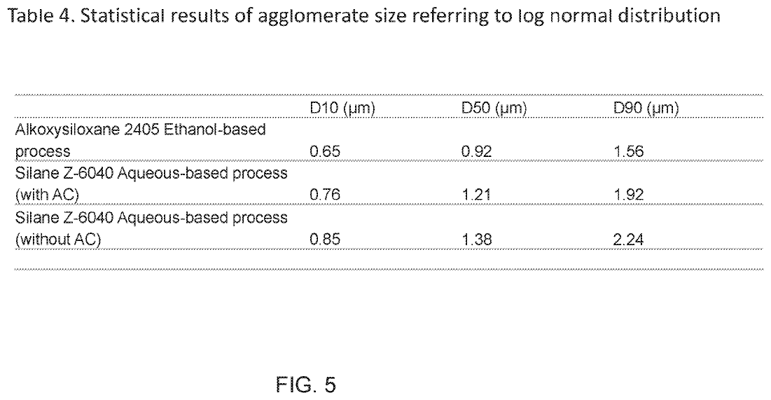

Comparing FIG. 4A and FIG. 4B, even though ICP analysis revealed different adhesion behavior between those two conditions, the appearance of the agglomerates under SEM seem to be generally similar to each other with minimal identifiable formation differences of agglomerates. The histogram statistics of all measurement diameters were shown in FIG. 4D and log normal distribution was used to fit the results. Overall, samples with acetic acid had a slightly smaller agglomerate size, with a D50 of 1.21 μm, compared to samples made with a batch without acetic acid, which had D50 of 1.38 μm. The accumulative log normal distribution of the two processes (with and without acetic acid) were also compared in FIG. 4C. From the accumulative log normal distribution fitting results, D10, D50 and D90 of agglomerates (agglomerate size) are summarized in Table 4 of FIG. 5. For reference, Table 4 also includes measured agglomerate size distribution for a separate ethanol-based process.

Exemplary embodiments as disclosed herein were produced by the following process.

### Step 1—Raw Materials Batching

Step 1—Raw materials batching process: a stable aqueous-based alumina suspension or slurry was the overall first step of this process. The binding effect on the inorganic surface treatments were provided by two organic chemical components in this aqueous-based suspension recipe, binder Z-6040, and additive polyethylene glycol (PEG) with a molar weight of 400 (PEG400). In one or more embodiments, polyethylene glycol (PEG), for example, a branched PEG having 3-10 PEG chains, for example a PEG with 9 PEG chains and a molar weight of 400 (PEG400) can be used in the aqueous mixture. In some embodiments, the addition of the PEG creates a dispersant effect in an aqueous-based mixture.

In other known applications, Z-6040 (3-glycidyloxypropyltrimethoxysilane) has been used to provide adhesion between an organic polymer and an inorganic substrate. However, in embodiments of the present disclosure, the addition of the silane binder, like Z-6040, serves the function of binding alumina agglomerates to other alumina agglomerates, or alumina agglomerates to alumina particles, or of binding alumina agglomerates or alumina particles to a porous ceramic honeycomb wall, like a porous cordierite wall, to form a surface treatment or structural feature which may take the form of isolated deposits, a membrane, or a layer or layers, disposed on filter body walls, like gasoline particulate filters or diesel particulate filters. In contrast, in a known ethanol-based process, an alkoxysiloxane (Dowsil-2405) was used.

Suspension batching process can begin with milling raw Almatis alumina powder (for example primary particle size or median particle size is D50 at 0.7 μm) with de-ionized water (“DI water”) on UP mill equipment, for example at 1000 rpm for about 2.5 hours, to obtain a concentrated aqueous alumina suspension. The resulting suspension should have a solid loading between 30% to 40%. The alumina particles can be spherical, rod-like, flat or irregular in shape. The silane binder (Dowsil Z-6040) and PEG400 was mixed in a waterless environment (separated from the silane binder) to prevent premature hydrolysis and condensation of Z-6040. We found that all the organic chemicals need to be mixed well before hydrolysis reactions begin in aqueous phase. Then, the “binder” mixture is added into the milled concentrated aqueous alumina suspension, stirred for a period of time (for example about 30 minutes) to achieve an adhesion effect of TO state of Z-6040 in aqueous phase. Then the well-reacted concentrated alumina binder aqueous solution is mixed with remaining DI water to get the final suspension. The final suspension is preferably mixed by magnetic stirring for at least 15 minutes with care taken to avoid overmixing which might produce over-condensed Z-6040, which might have a negative impact on inorganic surface treatment (IST) strength and/or durability. The composition of the suspension can be varied based on production needs or the intended application; in the examples herein, the compositions were 11% alumina, 3.3% Z-6040 and 1% PEG400 to produce an IST that will provide a final gasoline particulate filter with commercially satisfactory filtration efficiency and reliability, as well as minimal impact on pressure drop across the filter body. Suspension mixing can be done mechanically or acoustically. The as-prepared suspension may be stable for at least 1 hour without significant settlement or other deformities that may affect the deposition process or product quality; introducing a dispersant such as acetic acid or Darvan-CN (a commercial dispersant) can help on suspension settlement.

### Step 2. Spray-Drying Process and Aerosol Deposition

Step 2. Spray-drying process and aerosol deposition: An aerosol generation and deposition system were used to build up inorganic agglomerates in/on GPF walls.

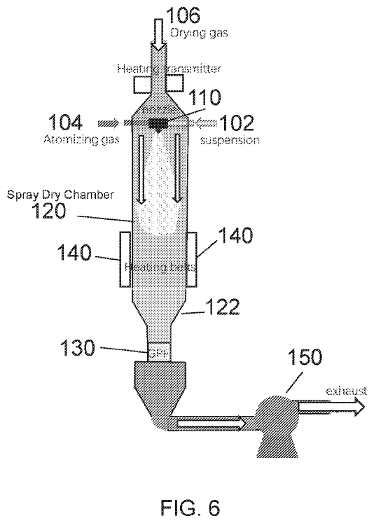

FIG. 6 shows a schematic of a co-flow aerosol generation and deposition system 100, which includes liquid 102 and gas 104 delivery system, spray nozzle 110, deposition chamber 120, (GPF) filter body holder 130, chamber heater or heating belts 140 and fan blower 150. FIG. 6 illustrates a co-flow system wherein carrier gas (or “drying gas”) flow and nozzle spray flow in the same direction. The system chamber 120 was round, with a converging part 122 added above filter body holder 130. Spray-drying may also be accomplished using other systems described in US-2021-0347702 A1. Alumina agglomerates were generated through a two-phase external mixing flow nozzle and dried by heated air. Aqueous-based suspension was atomized by pressurized nitrogen gas at the outlet of the spray nozzle. The atomized suspension droplet was dried by thermal convection and driven by the co-flow fluid motion. Dried alumina agglomerates with binder were deposited in/on the GPF plugged honeycomb wall surface and bonded together to form a structure that provides high filtration efficiency with minimal pressure drop penalty, as well as a durable inorganic wall surface treatment.

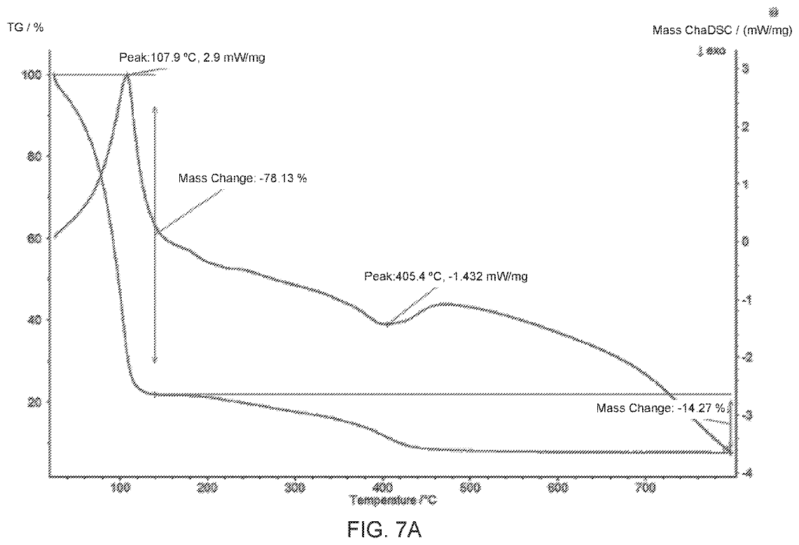

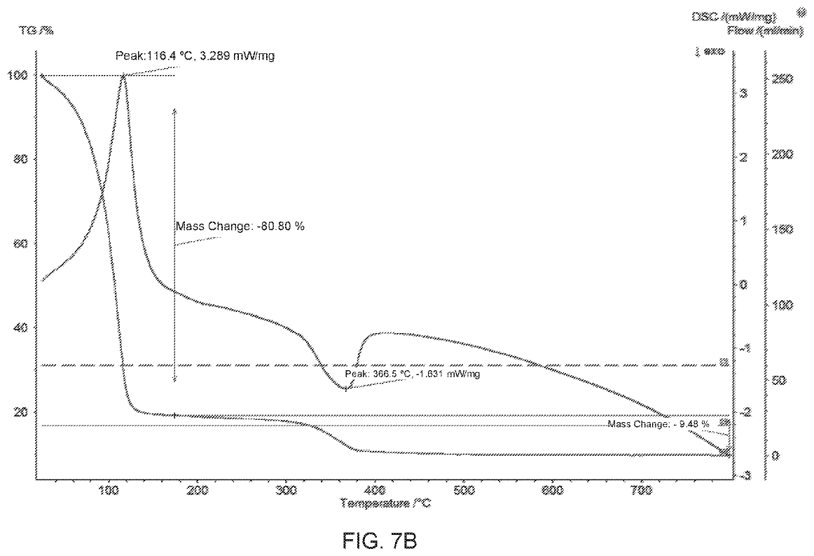

Thermogravimetric (TG) analysis was performed on an aqueous solution containing Dowsil Z-6040. FIG. 7A shows TG analysis of 20% (ratio of 6040/PEG400: 3.3/1) aqueous solution. FIG. 7B shows TG analysis of 20% 6040 aqueous solution. Based on TG analysis, the chamber temperature was set at 120 °C to avoid chemical character change during deposition process.

### Step 3. IST Curing Treatment

Step 3. IST curing treatment: GPF samples with as-deposited inorganic surface treatment were put into an oven (with air recirculation) and maintained preferably at a temperature and for a time which allows the silane binder to condense and form poly silane to enhance the agglomerate bonding strength, for example 200 °C for 1 h (1 hour) for the samples disclosed herein.

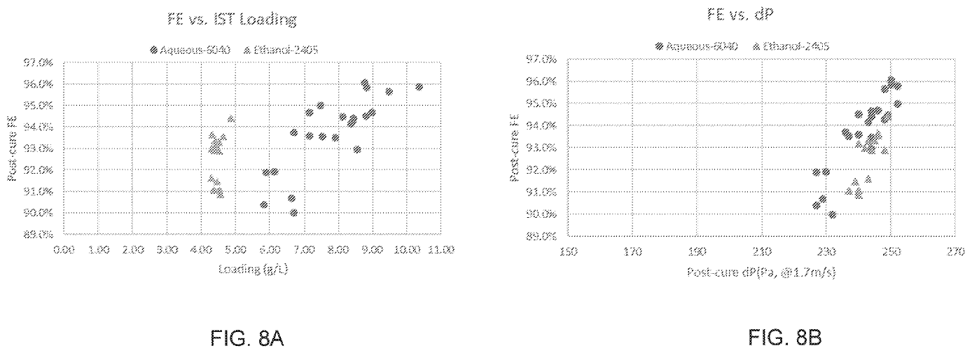

FIGS. 8A-8B graphically illustrate the comparison of performance factors (FE vs. Loading, and FE vs. dP) between samples with ethanol-based IST and aqueous-based IST. For the samples corresponding to FIGS. 8A-8B, 300 nm cigarette smoke particulate was used to measure the filtration efficiency of GPF samples with as-deposited inorganic surface treatment, and pressure drop was measured with 1.7 m/s contact flow rate, wherein the IST loading was based on sample weight before deposition and after cure. Aqueous-based samples utilized higher IST loading than comparable ethanol-based samples to achieve similar FE. On the other hand, GPF samples with aqueous-based IST provided a slightly lower pressure drop penalty compared to ethanol-based samples.

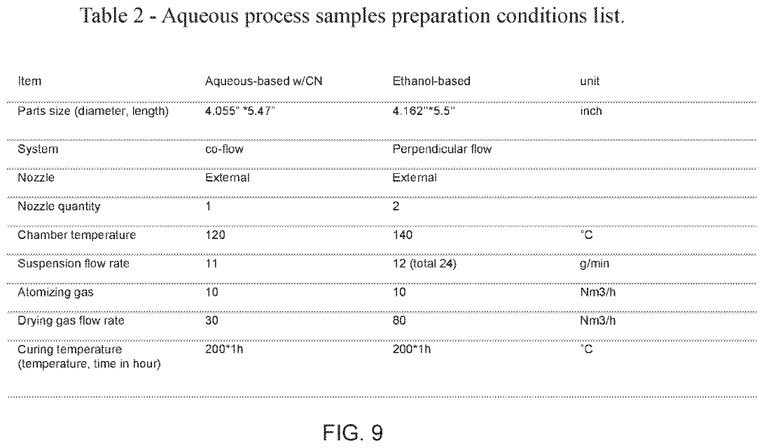

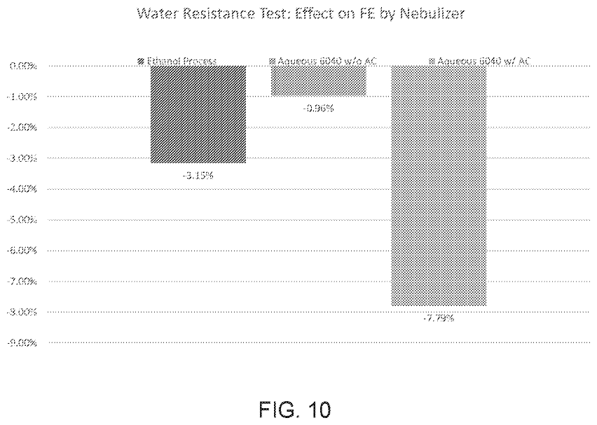

We evaluated two (2) parallel conditions for IST reliability based on the ICP result. The difference between these 2 conditions was whether acetic acid was added prior to 6040 or after 6040, and based on the ICP result, any difference in IST reliability was noted. Two duplicate aqueous-based samples were prepared for each condition, and two more sample were prepared by an ethanol-based process for reference. The preparing conditions are shown listed as Table 2 in FIG. 9. Here, the IST reliability was based on a nebulizer test.

All the aqueous samples were loaded with IST deposits in the range of 7.0 to 8.8 grams/Liter and clean, as deposited FE as measured by cigarette smoke were above 90%. A nebulizer test protocol was implemented to measured durability of the IST deposits and the final water loading was up to 70 g. The aqueous-based process samples were prepared using a co-flow spray drying system, with conditions listed in Table 2. Test results from the two processes are compared in FIG. 10, and sample details are listed in Table 2 of FIG. 9.

As seen in FIG. 10, the durability, or reliability, result for the sample from the aqueous-based process using silane binder 6040 follows ICP analysis, where acetic acid was added prior to 6040 into the suspension, fewer 6040 adhered on alumina particles, and less water resistance observed, i.e. more of a degradation in FE when evaluated by nebulizer test. With about 7.0 g/L aqueous IST loading, the aqueous-based process disclosed herein can build even more reliable inorganic deposits and/or layers as compared to inorganic surface treatment on plugged honeycomb bodies utilizing the ethanol-based process.

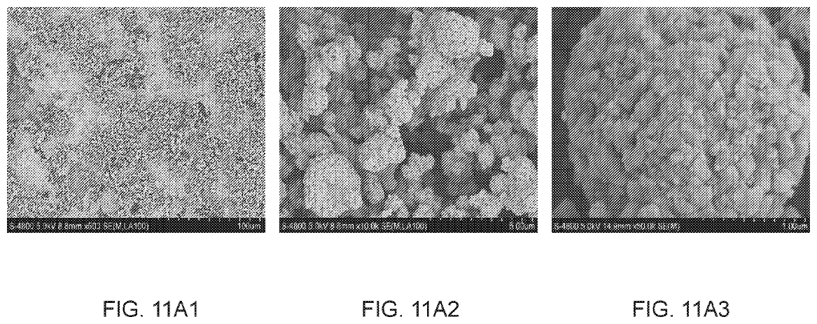

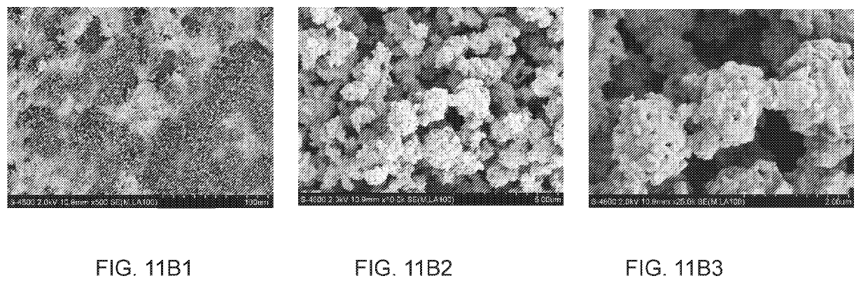

As evidenced by the SEM images shown in FIG. 11A1-11A3 (aqueous process without acetic acid as disclosed herein) and FIG. 11B1-11B3 (ethanol process), “snowball” shaped agglomerates were formed during spray-drying and deposited on and/or under the surface layer of the GPF plugged honeycomb body wall, wherein packing morphologies generated from aqueous-based and ethanol-based process are shown separately in FIG. 11A1-11A3 and FIG. 11B1-11B3, respectively. For the samples, the aqueous-based “snowball” agglomerates size was larger than ethanol-based ones, and no less than 200 agglomerate diameters were measured from the SEM images for each kind of process. Overall aqueous agglomerate sizes were larger than ethanol agglomerate sizes. From accumulative log normal distribution fitting results, D10, D50 and D90 of agglomerates are summarized in Table 4 of FIG. 5. The median agglomerate size D50 of the two processes was 0.92 μm (ethanol) and 1.38 μm (aqueous), respectively.

SEM images of different magnification levels of aqueous-based process alumina agglomerates deposits are shown in FIGS. 11A1-11A3 (a) high resolution SEM images of single agglomerate in FIG. 11A3 shown that the agglomerate was made up of primary alumina particles. There was no detectable evidence of non-alumina particles mixed with primary alumina particles to form the agglomerate. Preferably, the binder is uniformly distributed which helps to provide more effective binding and to help bind agglomerate to agglomerate or agglomerate to GPF wall. Aqueous-based “snowball” size was larger than ethanol-based ones, but spherical rate of ethanol-based was higher than that of aqueous-based. Bridging over open pores, or filament structure comprised of agglomerates, was observed in ethanol-based packing structure, while more independent agglomerates were observed in aqueous-based packing structure. No fewer than 200 agglomerate diameters were measured from the SEM images for each kind of process. Agglomerate packing structure is shown in FIG. 11A2, and compared to ethanol-based agglomerate packing in FIG. 11B2, aqueous-based agglomerates appear to stack similarly to ethanol-based agglomerate formations. FIG. 11A3 shows that some agglomerates were deposited both in the opening pores of wall and under the wall. A non-continuous deposition of inorganic agglomerates was built up during the deposition. Comparing to FIG. 11B3, aqueous-based agglomerates stacking structure on GPF are similar to ethanol-based agglomerates.

### General Overview of Honeycomb Bodies

The ceramic articles herein comprise honeycomb bodies comprised of a porous ceramic honeycomb structure of porous walls having wall surfaces defining a plurality of inner channels.

In some aspects, the porous ceramic walls comprise a material such as a filtration material which may comprise in some portions or some embodiments a porous inorganic layer disposed on one or more surfaces of the walls. In some embodiments, the filtration material comprises one or more inorganic materials, such as one or more ceramic or refractory materials. In some embodiments, the filtration material is disposed on the walls to provide enhanced filtration efficiency, both locally through and at the wall and globally through the honeycomb body, at least in the initial use of the honeycomb body as a filter following a clean state, or regenerated state, of the honeycomb body, for example such as before a substantial accumulation of ash and/or soot occurs inside the honeycomb body after extended use of the honeycomb body as a filter.

In one aspect, the filtration material is present in some portions or some embodiments as a layer disposed on the surface of one or more of the walls of the honeycomb structure. The layer in some embodiments is porous to allow the gas flow through the wall. In some embodiments, the layer is present as a continuous coating over at least part of the, or over the entire, surface of the one or more walls. In some embodiments of this aspect, the filtration material is flame-deposited filtration material.

In another aspect, the filtration material is present as a plurality of discrete regions of filtration material disposed on the surface of one or more of the walls of the honeycomb structure. The filtration material may partially block a portion of some of the pores of the porous walls, while still allowing gas flow through the wall. In some embodiments of this aspect, the filtration material is aerosol-deposited filtration material. In some preferred embodiments, the filtration material comprises a plurality of inorganic particle agglomerates, wherein the agglomerates are comprised of inorganic or ceramic or refractory material. In some embodiments, the agglomerates are porous, thereby allowing gas to flow through the agglomerates.

In some embodiments, a honeycomb body comprises a porous ceramic honeycomb body comprising a first end, a second end, and a plurality of walls having wall surfaces defining a plurality of inner channels. A deposited material such as a filtration material, which may be in some portions or some embodiments a porous inorganic layer, is disposed on one or more of the wall surfaces of the honeycomb body. The deposited material such as a filtration material, which may be a porous inorganic layer has a porosity as measured by mercury intrusion porosimetry, SEM, or X-ray tomography in a range of from about 20% to about 95%, or from about 25% to about 95%, or from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, or from about 20% to about 90%, or from about 25% to about 90%, or from about 30% to about 90%, or from about 40% to about 90%, or from about 45% to about 90%, or from about 50% to about 90%, or from about 55% to about 90%, or from about 60% to about 90%, or from about 65% to about 90%, or from about 70% to about 90%, or from about 75% to about 90%, or from about 80% to about 90%, or from about 85% to about 90%, or from about 20% to about 85%, or from about 25% to about 85%, or from about 30% to about 85%, or from about 40% to about 85%, or from about 45% to about 85%, or from about 50% to about 85%, or from about 55% to about 85%, or from about 60% to about 85%, or from about 65% to about 85%, or from about 70% to about 85%, or from about 75% to about 85%, or from about 80% to about 85%, or from about 20% to about 80%, or from about 25% to about 80%, or from about 30% to about 80%, or from about 40% to about 80%, or from about 45% to about 80%, or from about 50% to about 80%, or from about 55% to about 80%, or from about 60% to about 80%, or from about 65% to about 80%, or from about 70% to about 80%, or from about 75% to about 80%, and the deposited material such as a filtration material, which may be a porous inorganic layer that has an average thickness of greater than or equal to 0.5 μm and less than or equal to 50 μm, or greater than or equal to 0.5 μm and less than or equal to 45 μm, greater than or equal to 0.5 μm and less than or equal to 40 μm, or greater than or equal to 0.5 μm and less than or equal to 35 μm, or greater than or equal to 0.5 μm and less than or equal to 30 μm, greater than or equal to 0.5 μm and less than or equal to 25 μm, or greater than or equal to 0.5 μm and less than or equal to 20 μm, or greater than or equal to 0.5 μm and less than or equal to 15 μm, greater than or equal to 0.5 μm and less than or equal to 10 μm. Various embodiments of honeycomb bodies and methods for forming such honeycomb bodies will be described herein with specific reference to the appended drawings.

The material in some embodiments comprises a filtration material, and in some embodiments comprises an inorganic filtration material. According to one or more embodiments, the inorganic filtration material provided herein comprises discrete regions and/or a discontinuous layer formed from the inlet end to the outlet end comprising discrete and disconnected patches of material or filtration material and binder and adhesion promoter comprised of primary particles in secondary particles or agglomerates that are substantially spherical. In one or more embodiments, the primary particles are non-spherical. In one or more embodiments, “substantially spherical” refers to agglomerate having circularity in cross section in a range of from about 0.8 to about 1 or from about 0.9 to about 1, with 1 representing a perfect circle. In one or more embodiments, 75% of the primary particles deposited on the honeycomb body have a circularity of less than 0.8. In one or more embodiments, the secondary particles or agglomerates deposited on the honeycomb body have an average circularity greater than 0.9, greater than 0.95, greater than 0.96, greater than 0.97, greater than 0.98, or greater than 0.99.

Circularity can be measured using a scanning electron microscope (SEM). The term “circularity of the cross-section (or simply circularity)” is a value expressed using the equation shown below. A circle having a circularity of 1 is a perfect circle.

Circularity=(4π×cross-sectional area)/(length of circumference of the cross-section)².

Although the deposited material, which may be an inorganic layer, on the walls of the honeycomb body may, in some embodiments, cover substantially 100% of the wall surfaces defining inner channels of the honeycomb body, in other embodiments, the material, which may be an inorganic layer, on the walls of the honeycomb body covers less than substantially 100% of the wall surfaces defining inner channels of the honeycomb body. For instance, in one or more embodiments, the deposited material, which may be an inorganic layer, on the walls of the honeycomb body covers less than 70% of the wall surfaces defining inner channels of the honeycomb body, covers less than 75% of the wall surfaces defining inner channels of the honeycomb body, covers less than 80% of the wall surfaces defining inner channels of the honeycomb body, covers less than 85% of the wall surfaces defining inner channels of the honeycomb body, covers less than 90% of the wall surfaces defining inner channels of the honeycomb body, or covers less than 85% of the wall surfaces defining inner channels of the honeycomb body.

The selection of a honeycomb body having a low pressure drop in combination with the low thickness and porosity of the filtration material on the honeycomb body according to embodiments allows a honeycomb body of embodiments to have a low initial pressure drop when compared to other honeycomb bodies. In embodiments, the loading of the layer is in a range of from 0.3 to 30 g/L on the honeycomb body, such as in a range of from 1 to 30 g/L on the honeycomb body, or in a range of from 3 to 30 g/L on the honeycomb body. In other embodiments, the loading of the layer is in a range of from 1 to 20 g/L on the honeycomb body, such as in a range of from 1 to 10 g/L on the honeycomb body. In specific embodiments, the loading of the layer is in a range of from 1 to 9 g/L, 1 to 8 g/L, 1 to 7 g/L, 1 to 8 g/L, 1 to 5 g/L, 1 to 4 g/L, 1 to 3 g/L, 2 to 10 g/L, 2 to 9 g/L, 2 to 8 g/L, 2 to 7 g/L, 2 to 6 g/L, 2 to 5 g/L, 2 to 4 g/L, 3 to 10 g/L, 3 to 9 g/L, 3 to 8 g/L, 3 to 7 g/L, 3 to 6 g/L, 3 to 5 g/L, 4 to 10 g/L, 4 to 9 g/L 4 to 8 g/L, 4 to 7 g/L, or 4 to 6 g/L on the honeycomb body. In some embodiments, the increase in pressure drop across the honeycomb due to the application of the porous layer across is less than 20% of the uncoated honeycomb. In other embodiments that increase can be less than or equal to 9%, or less than or equal to 8%. In other embodiments, the pressure drop increase across the honeycomb body is less than or equal to 7%, such as less than or equal to 6%. In still other embodiments, the pressure drop increase across the honeycomb body is less than or equal to 5%, such as less than or equal to 4%, or less than or equal to 3%.

Without being bound to any particular theory, it is believed that small pore sizes in the filtration material deposits on the walls of the honeycomb body allow the honeycomb body to have good filtration efficiency even before ash or soot build-up occurs in the honeycomb body. The filtration efficiency of honeycomb bodies is measured herein using the protocol outlined in Tandon et al., 65 CHEMICAL ENGINEERING SCIENCE 4751-60 (2010). As used herein, the initial filtration efficiency of a honeycomb body refers to a new or regenerated honeycomb body that does not comprise any measurable soot or ash loading. In embodiments, the initial filtration efficiency (i.e., clean filtration efficiency) of the honeycomb body is greater than or equal to 70%, such as greater than or equal to 80%, or greater than or equal to 85%. In yet other embodiments, the initial filtration efficiency of the honeycomb body is greater than 90%, such as greater than or equal to 93%, or greater than or equal to 95%, or greater than or equal to 98%.

The material, which is in some embodiments an inorganic filtration material, on the walls of the honeycomb body according to embodiments is thin and has a porosity, and in some embodiments also has good chemical durability and physical stability.

In some embodiments, the honeycomb body may have one or more of the channels plugged on one end, such as, for example, the first end of the honeycomb body during the deposition of the aerosol to the honeycomb body. The plugged channels may, in some embodiments, be removed after deposition of the aerosol. But, in other embodiments, the channels may remain plugged even after deposition of the aerosol. The pattern of plugging channels of the honeycomb body is not limited, and in some embodiments all the channels of the honeycomb body may be plugged at one end. In other embodiments, only a portion of the channels of the honeycomb body may be plugged at one end. In such embodiments, the pattern of plugged and unplugged channels at one end of the honeycomb body is not limited and may be, for example, a checkerboard pattern where alternating channels of one end of the honeycomb body are plugged. By plugging all or a portion of the channels at one end of the honeycomb body during deposition of the aerosol, the aerosol may be evenly distributed within the channels of the honeycomb body.

The aqueous process according to one or more embodiments herein forms deposits having a microstructure of densely packed agglomerates which are porous.

Thus, according to one or more embodiments, the inorganic deposits are comprised of individual agglomerates of nanoparticles (e.g., spherical agglomerates of nanoparticles), aggregates of agglomerates, and/or porous clusters or chains of aggregates of spherical agglomerates, wherein some clusters or chains are disposed within pores in or below the surface of the porous ceramic wall, and/or wherein some clusters are disposed on the surface of the porous ceramic wall. In some embodiments, some of the porous clusters are porous clusters or cluster islands comprising exposed aggregates of agglomerates (e.g., spherical agglomerates). In some embodiments, the porous clusters or cluster islands comprise one or more chains of two or agglomerates, each chain extending in a substantially outward direction from the porous ceramic wall. In some embodiments, at least one chain includes a free end of the chain projecting above the surface of the porous ceramic wall. In some embodiments, the inorganic material on the honeycomb body is present as inorganic deposits comprising a network of aggregated spherical agglomerates of inorganic material particles.

Wall-flow filters. The diameter and length of the wall-flow filter bodies (or “filter substrates”) used in the examples were 4.055″ and 5.47″. The CPSI and wall thickness were 200 and 8 mils. The median pore size was 14 microns.

According to one or more embodiments, a honeycomb filter body comprising inorganic deposits disposed within the honeycomb filter body to create a filtration article can be characterized according to one or more of the following tests.

### Smoke Filtration Efficiency (FE)

The smoke filtration efficiency performance of the deposited inorganic material disposed within the honeycomb filter bodies was evaluated using a smoke filtration test.

The filtration efficiency (in percent %) is calculated as:

$$F E = ( 1 - \frac{{C}_{outlet}}{{C}_{inlet}} ) * 100 ,$$

where C is the smoke concentration on the outlet and inlet side of the part, respectively.

Two particle counter units (Lighthouse 2016, USA) are used simultaneously at upstream and downstream positions with respect to the article at the underfloor position of a dilution chamber. A cigarette is lit in a smoke generator to provide desired quantity of soot particles into the dilution chamber and the concentration is maintained at a certain level (500,000 particles/cm³) before the smoke travels into the inlet side of the tunnel. The flow is driven by a blower which carries the soot particles through the tunnel and eventually into the wall flow filter parts. When the concentration at upstream of GPF reaches a stable state, the two particle counters reset to begin counting for 60 seconds and filtration efficiency (FE) was calculated based on the differential of total particle count of 0.3 μm and above. The pressure drop (dP) measured by pressure gauges located upstream and downstream from the article is also recorded at a fixed flow of 51 Nm³/hr.

Pre-Test Canning. During pre-test canning, an article is wrapped in a ceramic fiber mat material and then placed into a metal can. The article, mat and can assembly are heated in an oven to 650 °C and held at 650 °C for a duration. The mat expands to help hold the article in place within the can. This process is referred to as mat popping as the mat expands, it “pops” inside the can to fit the article in place. The duration of the pre-test canning is chosen based on the subsequent test being conducted.

Post-Test Cleanout. After a test is conducted, the following steps are completed to achieve post-test cleanout of the article. The article, mat and can assembly are placed in an oven at 650 °C and held at 650 °C for a duration, usually about 6 hours so that the soot that was loaded into the article is burned out of the article.

### Clean Filtration Efficiency

As used herein, the “clean filtration efficiency” of a honeycomb body or filtration article refers to a new or regenerated honeycomb body that does not comprise any measurable soot loading. In embodiments, the clean filtration efficiency of the honeycomb body or filtration article is greater than or equal to 70%, such as greater than or equal to 80%, or greater than or equal to 85%. In yet other embodiments, the initial filtration efficiency of the honeycomb body or filtration article is greater than 90%, such as greater than or equal to 93%, or greater than or equal to 95%, or greater than or equal to 98%.

As used herein, “Clean Filtration Efficiency Test” refers to testing an article as follows.

After pre-test canning for 6 hours, an air stream is supplied by a blower upstream of the article at a ramped rate, and clean pressure drop is measured across the filter using a differential pressure sensor/gauge at room temperature (about 25 °C). The flow rate of the air stream was ramped from 25.5 m³/h to 356.8 m³/h over 10 step increases, where the flow rate was maintained for one minute at each new step increase. Each step increase was in a range of about 8 to 68 m³/h. Next, an air stream containing soot particles at a concentration of 8 mg/m³ and a flow rate of 22.5 m³/h is introduced upstream of the filter for 45 minutes. The soot is generated at ~110 nm particle size from a commercially available propane burner. Clean filtration efficiency at 30 °C is determined by measuring the difference between a number of particulates that are introduced into the article and a number of particulates that exit the article before and after exposure to the flow conditions. After the clean filtration efficiency is measured, post-test cleanout is conducted for 6 hours.

### Water Exposure Tests

Several assessment protocols for understanding the durability of the filtration articles disclosed herein were utilized. Analysis of impact of water exposure of varying intensities on honeycomb filter bodies having aerosol-deposited inorganic material is an indication of the durability of the filtration articles.

### Water Soak Test

As used herein, “Water Soak Test” refers to testing an article as follows.

To simulate conditions where a vehicle exhaust pipeline has seen incoming water source in an underfloor condition, the water soak test was conducted.

An article is first measured for baseline FE/dP measurement by the clean filtration efficiency test.

Next, the article is weighed at 75 °C to determine an initial weight. The article is then placed on its side in a petri dish, skin layer side, to simulate an underfloor position of the filter in a vehicle exhaust system and soaked in a quantity of deionized water for 2 hours. After the part soaks up water to a target amount, it is dried at 75 °C until completely dry (weight goes back to as-deposited state). The target quantity of water may be premeasured. For example, nominally 300 grams of water may be used. In one or more embodiments, there is a water absorption level that can be described as a percentage of a distance along a diameter of the article face the water absorbed, e.g., ½ to ¾ of a filter diameter. The article is then dried in a furnace for 5-6 hours at 100 °C until the initial weight is achieved. Next, clean filtration efficiency is measured. For evaluating clean filtration efficiency, an air stream containing soot particles at a concentration of 8 mg/m³ and a flow rate of 22.5 m³/h is introduced upstream of the filter for 45 minutes. The soot is generated at ~110 nm particle size from a commercially available propane burner. Clean filtration efficiency at 30 °C is determined by measuring the difference between a number of particulates that are introduced into the article and a number of particulates that exit the article. After the filtration efficiency is measured, post-test cleanout is conducted for 6 hours. Filtration efficiency at 0 g/L soot is compared before and after the article is exposed to the water soak test.

### Water Immersion Test

Another method for evaluating durability of a filtration article is the water immersion test, where a part is completely soaked in water to imitate the worst case scenario where an exhaust pipeline is submerged in water.

As used herein, “Water Immersion Test” refers to testing an article as follows.

An article is first measured for baseline FE/dP measurement by the clean filtration efficiency test.

Next, the article is weighed at 75 °C to determine an initial weight. The article with inlet end face down is slowly immersed into a vessel of water over a duration of time. The quantity of water depends on the size of the article in order to fully immerse the article. The sample remains still in the water for 1 minute and then is slowly removed from the water and allowed to sit for 2 hours. The article is weighed. Then the filter is dried in a furnace for 5-6 hours at 100 °C until the initial weight is achieved. Another clean filtration efficiency measurement is conducted to evaluate the filtration efficiency change after exposure to water.

### Water Nebulizer Test

As used herein, “Water Nebulizer Test” refers to testing an article as follows. The article is placed in a can which contains a bladder. The bladder is inflated with air to hold the filter in place. Next, clean pressure drop is measured across the filter using a differential pressure sensor/gauge at room temperature (about 25 °C). The flow rate of the exhaust gas upstream from the assembly is ramped from 25.5 Nm³/h to 356.8 Nm³/h over 10 step increases, where the flow rate was maintained for one minute at each new step increase. Each step increase is in a range of about 8-68 Nm³/h. Next, filtration efficiency is measured at 30 °C, with the exhaust flow rate at 21 Nm³/h and 120 nm median particle diameter soot particles at a concentration of 8.5 mg/m³ introduced upstream of the filter using a propane burner for 45 minutes. Particle mass and particle number is measured upstream and downstream of the filter using a AVL microsoot sensor and TSI Engine Exhaust Particle Sizer (EEPS), respectively. After the filtration efficiency is measured, the article is removed from the can and placed in an oven at 650 °C and held at 650 °C for 9 hours so that the soot that was loaded into the article was burned out of the honeycomb.

The article is weighed at room temperature. The article is exposed to a fine mist or spray of water using a nebulizer or atomizer as described in U.S. Pat. No. 7,520,918 until the part is exposed to 15 g/L of water. Next the article is dried in an oven using 250 °C for 3 hours. Then, the article and can assembly are tested for filtration efficiency at 21 Nm³/hr at 30 °C and 8.5 mg/m³ and the filtration efficiency at 0 g/L soot is compared to that measured before the 650 °C heat treatment and nebulizer water exposure. Then, a cleanout procedure is performed on the article in an oven at 650 °C for 12 hours. The filter is then removed from the can and exposed to a fine mist or spray of water using a nebulizer or atomizer as described in U.S. Pat. No. 7,520,918 until the part was exposed to 15 g/L of water. Next the article is dried in an oven using 650 °C for 9 hours. Then, the article and can assembly are tested for filtration efficiency at 21 Nm³/hr at 30 °C and 8.5 mg/m³. Filtration efficiency at 0 g/L soot measured after the second nebulizer water exposure is compared to the baseline filtration efficiency at 0 g/L soot prior to the first 650 °C heat treatment and nebulizer water exposure.

### High Flow Test

As used herein, “High Flow Test” refers to testing an article as follows.

An article is first measured for baseline FE/dP measurement by the clean filtration efficiency test.

Thereafter, high flow is introduced to the article. The flow rate of the exhaust gas upstream from the assembly is ramped from 85 m³/h to 850.8 m³/h over 10 step increases at about 25 °C, where the flow rate was maintained for one minute at each new step increase. Each step increase was in a range of about 85-170 m³/h. Next, an air stream containing soot particles at a concentration of 8 mg/m³ and a flow rate of 22.5 m³/h is introduced upstream of the filter for 45 minutes. The soot is generated at ~110 nm particle size from a commercially-available propane burner. Clean filtration efficiency at 30 °C is determined by measuring the difference between a number of particulates that are introduced into the article and a number of particulates that exit the article before and after exposure to the flow conditions. After the filtration efficiency is measured, post-test cleanout is conducted for 6 hours. Filtration efficiency at 0 g/L soot is compared before and after the article is exposed to the high flow test.

### Soot Loaded Pressure Drop Test

After pre-test canning for 6 hours, soot is loaded into the article with a flow rate of an exhaust gas upstream from the assembly ramped from 25.5 m³/h to 356.8 m³/h over 10 step increases at about 25 °C, where the flow rate was maintained for one minute at each new step increase. Each step increase was in a range of about 8-68 m³/h. Soot loading was increased from 0 g/L to 3 g/L. A soot loaded pressure drop is measured across the filter using a differential pressure sensor/gauge at room temperature (about 25 °C) after the filter is loaded with soot. After the soot loaded pressure drop was measured, post-test cleanout is conducted for 6 hours.

### Cold Vibration Test

An article is placed on a shaker table which vibrates in 2 directions and is vibrated at 706 m/s², 200 Hz for 2 hours along the longitudinal and cross-sectional axis.

### Vehicle Test

A canned article is installed on a vehicle which is driven on the highway simulating acceleration followed by a “fuel cut,” or reduction in speed. The article experiences short pulses of high temperature and high flow rate 5 times targeting 1000 m³/h for 30 seconds or more.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for treating a surface of a plugged honeycomb body comprising porous walls, the method comprising:
mixing inorganic particles and a silane binder mixture to form an aqueous mixture free of acetic acid, the silane binder mixture comprising a silane binder and water;
atomizing the aqueous mixture to form an aerosol stream of aerosolized deposit precursors comprising wetted inorganic particles and/or particle-containing droplets;
spray drying the aerosolized deposit precursors with a carrier gas to convey the aerosolized deposit precursors toward the plugged honeycomb body, the spray drying removing water from the wetted inorganic particles and/or the particle-containing droplets; and
wherein at least some of the aerosolized deposit precursors form agglomerates comprising the inorganic particles and the silane binder.

2.-4. (canceled)

5. The method of claim 1, wherein at least some of the agglomerates aggregate into clusters upon reaching the plugged honeycomb body.

6.-10. (canceled)

11. The method of claim 1, further comprising heating the plugged honeycomb body to cure the silane binder.

12.-15. (canceled)

16. The method of claim 11, wherein a temperature of the plugged honeycomb body during the heating does not exceed 130 °C.

17. The method of claim 11, wherein the curing causes the agglomerates to bind to the porous walls of the plugged honeycomb body and/or to each other.

18. The method of claim 11, wherein substantially all the water is removed from the agglomerates as a result of the curing.

19.-21. (canceled)

22. The method of claim 1, wherein the aqueous mixture is free of a siloxane.

23.-27. (canceled)

28. The method of claim 1, wherein the aqueous mixture is free of at least one of a siloxane or a silicate.

29.-30.

31. The method of claim 1, wherein the aqueous mixture is free of formic acid.

32. The method of claim 1, wherein the silane binder comprises one or more functional organic groups.

33. The method of claim 32, wherein the one or more functional organic groups comprises a glycidyl-group, an amine-group, a methacryl-group, a vinyl-group, or combinations thereof.

34. The method of claim 1, wherein the silane binder comprises a hydrolysis group comprising a methoxy-group, an ethoxy-group, or a combination thereof.

35. The method of claim 1, wherein the silane binder comprises one or more silylalkoxy groups.

36. The method of claim 1, wherein the silane binder mixture further comprises polyethylene glycol.

37. The method of claim 36, wherein the polyethylene glycol comprises a molar weight of 300 to 500.

38.-46. (canceled)

47. The method of claim 36, wherein the silane binder mixture is formed by mixing together the silane binder and the polyethylene glycol in a waterless environment, then mixing together with water.

48.-50. (canceled)

51. The method of claim 1, wherein a median particle size (d50) of the inorganic particles is less than 1.0 μm.

52.-53. (canceled)

54. The method of claim 1, wherein the aqueous mixture comprises 5 to 15 wt % of the inorganic particles, 2.0 to 5.0 wt % of the silane binder, and 0.5 to 2.0% polyethylene glycol.

55.-56. (canceled)

57. The method of claim 37, wherein the inorganic particles comprise alumina, the silane binder comprises 3-glycidyloxypropyltrimethoxysilane, and a molar weight of the polyethylene glycol is 400.

58. The method of claim 1, wherein the agglomerates are essentially spherical in shape.

59.-60. (canceled)
